(19) United States
(12) Patent Application Publication
(10) Pub. No.: US 2017/0253353 A1
(43) Pub. Date: Sep. 7, 2017

(54) INSTALLATION AND METHOD FOR REPACKAGING DIFFERENT MEDICINES FROM THEIR RESPECTIVE ORIGINAL BLISTER PACKS INTO ORGANISER BLISTER PACKS

(71) Applicant: Edwin Kohl, Perl (DE)

(72) Inventor: Edwin Kohl, Perl (DE)

(21) Appl. No.: 15/509,482

(22) PCT Filed: Sep. 3, 2015
(86) PCT No.: PCT/EP2015/070125

§ 371 Date: Mar. 7, 2017

(30) Foreign Application Priority Data
Sep. 8, 2014 (EP) 14183954.8

(51) Int. Cl. B65B 1/04; B65B 57/00; B65B 35/10; A61J 1/03; A61J 7/04

(52) U.S. Cl. CPC B65B 1/04; A61J 1/035; A61J 7/04; B65B 35/10; B65B 57/00

(57) ABSTRACT

The invention relates to an installation and a method for repackaging different medicines from their respective original blister packs into organiser blister packs, in particular weekly blister packs for an individual patient having receiving compartments arranged in a matrix configuration with rows corresponding to a number of times medicines are to be taken over the course of a day and columns corresponding to a number of days, for example days of the week. The installation proposed by the invention has a conveying device for singulating and conveying filled original blister packs, an intermediate storage facility with random access for intermediate storage of the original blister packs packed in blister pack supports of standard external dimensions assigned to a respective original blister pack type, and an ejection device for ejecting a defined number of units of a selected medicine from the respective original blister pack into the organiser blister pack.

### FIELD OF THE INVENTION

The invention relates to an installation and a method for repackaging different medicines from their respective original blister packs into organiser blister packs, in particular weekly blister packs for an individual patient, having receiving compartments arranged in a matrix configuration with rows corresponding to a number of times medicines are to be taken over the course of a day and columns corresponding to a number of days, for example days of the week.

### RELATED PRIOR ART

DE 10 2004 034 024 A2 discloses an individual blister pack for the weekly medicine requirements of a patient (weekly blister pack), which is intended to accommodate the medicines in an ordered sequence in which they are meant to be taken based on date, day of the week and time of the day (morning, midday and evening and/or night). The receiving compartments of the blister pack for accommodating the respective medicines are arranged in a matrix pattern with seven columns for days, each having at least three compartments for the time of day, all of which are closed by a cohesive blister pack foil. A card-shaped lid is applied to the blister pack, on which the make-up of the individual time of day compartments and the prescription information relating to the respective medicines specific to the patient is contained.

Such weekly blister packs are an aid for patients who have to take several different medicines regularly, on the one hand to ensure that they do not forget to take important medicines and also to maintain a reliable awareness as to which medicines have already been taken on the other hand, with a view to preventing over-medication which can be harmful under certain circumstances.

An installation for filling such blister packs with the desired make-up of medicines tailored to individual patients is known from WO 2005 102 841 A1. An output station is provided for each medicine which conveys the respective medicine from a passing packaging in the form of a blister strip into the corresponding receiving compartments of the packaging unit by means of rams arranged in a spatial configuration matching the receiving compartments of the blister pack. All of the patient-specific blister packs pass through all of the output stations of the installation on a cycle-timed basis and medicines are picked up at only those stations corresponding to the prescription data assigned to the individual blister pack. In this manner, patient-specific packaging units can be safely and reliably filled with a selection of several hundred medicines on a fully automated basis.

EP 2 754 615 describes an installation and method for packaging medicines in organiser blister packs tailored to individual patient requirements on the basis of predefined prescription data, and the organiser blister packs are conveyed individually one after the other in a direction of movement alongside a number of successively disposed medicine filling stations in order to fill the organiser blister packs respectively with a specific medicine, and every organiser blister pack is individually controlled so that it moves respectively for a filling operation to only the medicine filling stations needed to comply with the prescription data and bypasses the other medicine filling stations.

The problem which occurs with the installation described in EP 2 754 615 is that the number of medicines that can be processed corresponds to the number of filling stations and is therefore limited. Packaging the organiser blister packs with medicines that are seldom prescribed but which likewise require a separate filling station on an economic basis is therefore difficult with this packaging installation.

### SUMMARY OF THE INVENTION

Accordingly, the objective of the invention is to improve the installation described in EP 2 754 615 so that the number of medicines that can be processed is greater than the number of filling stations, i.e. to propose a filling station which is capable of filling the organiser blister pack with a number of different medicines.

The objective is achieved by a method for repackaging a plurality of different medicines from their respective original blister packs into organiser blister packs comprising the following method steps: assigning the original blister packs filled with medicines to a blister pack support of standard external dimensions provided for the respective original blister pack type, packing the original blister packs filled with medicines in the assigned blister pack support, intermediately storing the original blister packs packed in the blister pack supports in an intermediate storage facility, removing from the intermediate storage facility on request the original blister pack of a selected one of the plurality of medicines packed in the blister pack support, and ejecting a defined number of units of the selected medicine from the original blister pack into the organiser blister pack.

The objective is also achieved by an installation for repackaging a plurality of different medicines from their respective original blister packs into organiser blister packs, comprising a conveying device for singulating and supplying full original blister packs, an intermediate storage facility with random access for intermediate storage of the original blister packs packed in blister pack supports of standard external dimensions assigned to a respective original blister pack type, and an ejection device for ejecting a defined number of units of a selected medicine from the respective original blister pack into the organiser blister pack.

The invention also proposes a blister pack support for accommodating an original blister pack with medicines packed in it, comprising a support part with a number of openings for receiving the blister cavities of the original blister pack, a lid part with the same number of openings as ejection openings for the medicines packaged in the original blister pack, and an identifying means for identifying the blister pack support.

The invention therefore enables operation of a single medicine packing station, which is capable of filling organiser blister packs tailored to individual patient requirements with a number of different medicines in a controlled manner. The fact that the medicines are temporarily stored in their original blister packs enables a maximum shelf life to be obtained. The blister pack supports of standard external dimensions assigned to the respective medicine types enable efficient storage, handling and reliable deblistering of the original blister packs to be obtained.

The blister pack supports preferably each comprise a support part with a number of openings for receiving the blister cavities of the original blister pack and a lid part with the same number of openings as ejection openings for the medicines packaged in the original blister pack. In order to store original blister packs of different designs, the blister pack supports preferably comprise different patterns of openings for receiving different original blister packs.

The blister pack supports may also comprise an identifying means, such as an RFID chip or a bar code or QR code, for identifying the respective blister pack support and hence the type of medicine stored in it.

The intermediate storage facility for storing the original blister packs packed in the blister pack supports may be configured as a drawer storage facility, thereby enabling efficient storage in terms of space and random access to the blister pack supports.

As proposed by the invention, a deblistering device having a plurality of different medicine ejection rams is preferably provided, which are each adapted to a specific medicine and/or original blister pack shape and/or the openings of the blister pack support. The different medicine ejection rams are preferably mounted rotatably about an axis for random access.

The deblistering device may comprise a perforation means for perforating the blister film in the area of the blister cavities of the medicines to be ejected from the original blister pack.

The original blister pack preferably remains in the blister pack support during the process of ejecting the medicines, and the original blister pack is placed on the blister pack support oriented with its blister cavities facing downwards and the medicines can be ejected from the original blister packs in reverse orientation with the blister cavities facing upwards.

In order to increase the efficiency of the installation, the medicines are ejected from the original blister pack into a predispensing magazine and are conveyed from there into the organiser blister pack in a time-decoupled second working step. This enables the time-critical operation of filling the organiser blister pack to be decoupled from the mechanically difficult operation of ejecting the medicines from the original blister pack.

Optical sensor means are preferably provided for verifying proper ejection of the selected medicines from the original blister pack into the predispensing magazine and/or correct filling of the organiser blister packs.

Original blister packs that are still partly filled are preferably returned to the intermediate storage facility together with the blister pack support and completely empty original blister packs are disposed of accordingly.

### BRIEF DESCRIPTION OF THE DRAWINGS

The invention will be described in more detail below with reference to examples of embodiments illustrated in the drawings.

FIG. 1A is a schematic, perspective view of the intermediate storage facility based on one example of an embodiment of the installation for repackaging medicines proposed by the invention.

FIG. 1B is a detailed view of the intermediate storage facility illustrated in FIG. 1A, in which a drawer of the storage facility is pulled out.

FIG. 2 is a schematic, perspective view of three examples of embodiments of blister pack supports proposed by the invention in an open position.

FIG. 3 is a schematic, perspective view of the three examples of embodiments of blister pack supports proposed by the invention illustrated in FIG. 2 but in a closed position.

FIG. 4 is a schematic, perspective view of an example of an embodiment of a deblistering device and a predispensing magazine of the installation for repackaging medicines proposed by the invention.

FIG. 5 is a schematic, perspective view of an example of an embodiment of a perforation means of the installation for repackaging medicines proposed by the invention, disposed upstream of the deblistering device.

FIG. 6 is a schematic, perspective diagram of the operation of transferring the medicines from the predispensing magazine to the organiser blister pack based on one example of an embodiment of the method proposed by the invention for repackaging medicines.

FIG. 7 is a schematic flow diagram illustrating the method steps based on one example of an embodiment of the method proposed by the invention for repackaging medicines.

### DETAILED DESCRIPTION OF THE INVENTION

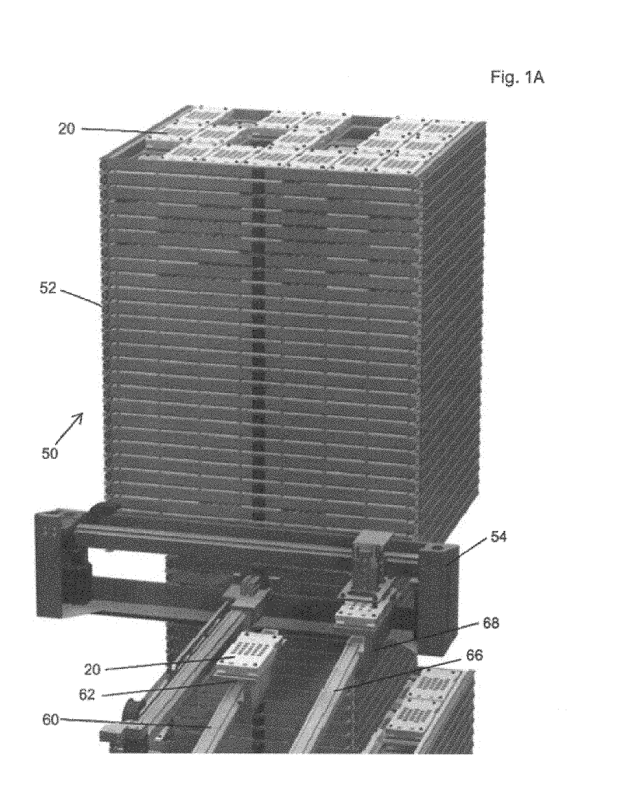

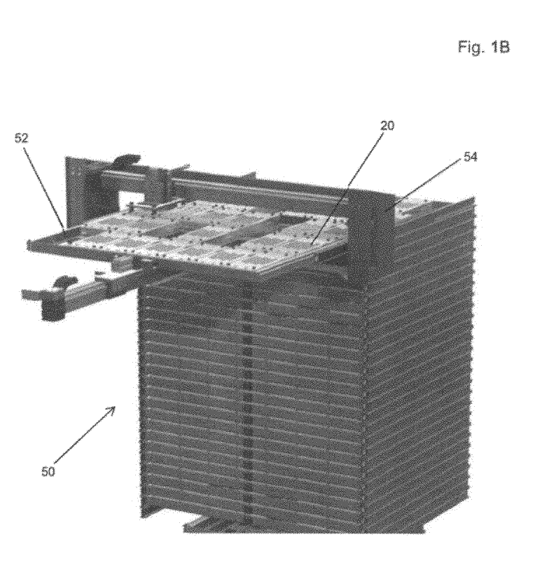

An example of an embodiment of the installation proposed by the invention and the method proposed by the invention for repackaging medicines from their respective original blister packs into organiser blister packs tailored to individual patient requirements will be explained in detail below with reference to FIGS. 1-7.

The installation proposed by the invention and the method proposed by the invention are used to repackage a larger number (for example 100) of different medicines which are typically supplied in differently shaped original blister packs. The individual medicines are delivered in the original packaging and the blister packs are removed from the respective outer packaging (not illustrated) and separated manually or mechanically. The separated original blister packs 10 are then assigned to appropriate blister pack supports 20 which are used for packaging and storing the different medicines in their respective original blister packs 10 in the intermediate storage facility 50 proposed by the invention (FIGS. 1A and 1B). Blister pack supports 20 as provided by the invention cater for all desired medicine types, and different medicines with similarly shaped original blister packs 10 can be assigned to identical blister pack supports 20. It is important that external dimensions of all the blister pack supports 20 are standardised, preferably identical.

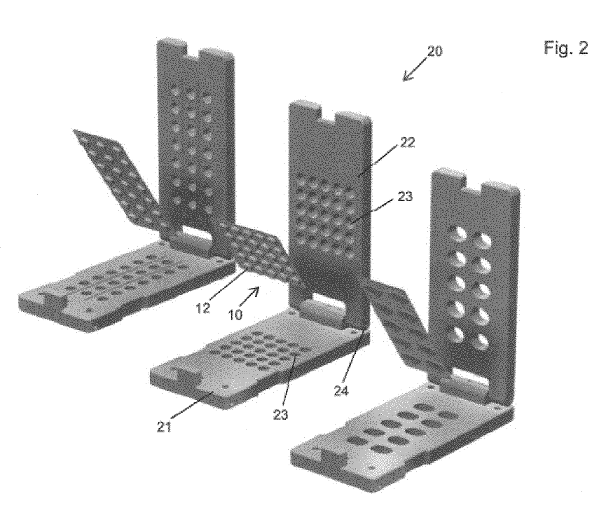

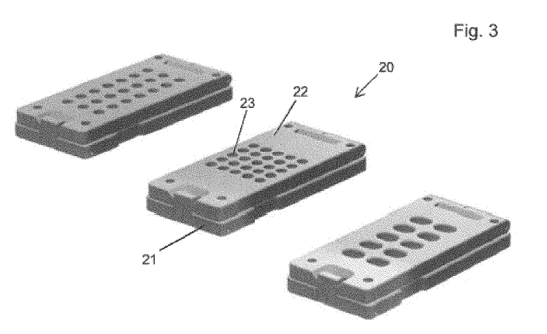

Three examples of embodiments of blister pack supports 20 proposed by the invention are schematically illustrated in FIGS. 2 and 3. A blister pack support 20 comprises a support part 21 and a lid part 22 linked by means of a hinge connection 24 or similar. The support part 21 and lid part 22 each have openings 23 arranged in a pattern matching the respective original blister pack 10. The original blister pack 10 is placed on the arrangement of openings 23 of the support part 21 of the blister pack support 20 with the foil side facing upwards, as illustrated in FIG. 2. The arrangement of openings 23 thus accommodates the blister cavities 12 of the original blister pack 10. The lid part 22 is then closed, as illustrated in FIG. 3. The external dimensions of the blister pack supports 20 are preferably all identical so that the latter can be efficiently stored in the intermediate storage facility 50 and transported.

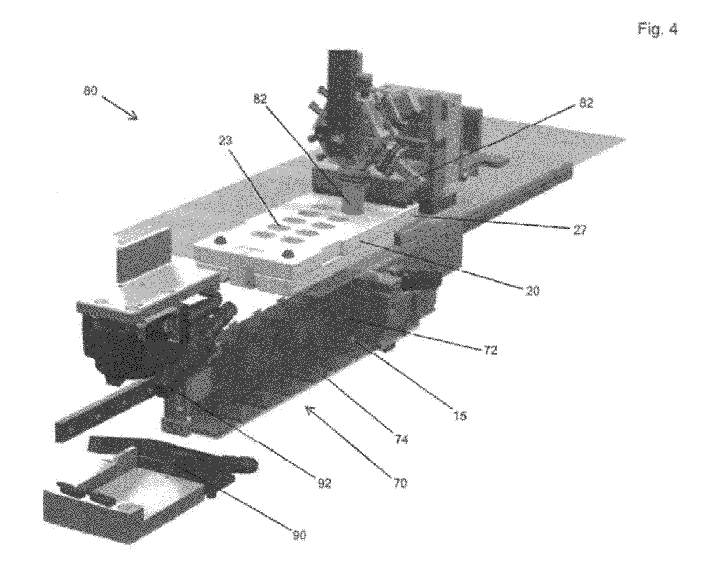

Every blister pack support 20 further comprises an identification means 27, such as an RFID chip 27 (FIG. 4) for identifying the medicine stored in the blister pack support 20.

As illustrated in FIG. 1A, the medicines packed in the blister pack supports 20 are conveyed by a conveyor carriage 62 of a type known on a conveyor line 60 to a drawer storage facility 50, likewise of a known type, in which the blister pack supports 20 are efficiently stored in drawers 52, which can be retracted and extracted by an actuating mechanism 54. FIG. 1B illustrates the drawer storage facility 50 with a drawer 52 extracted. The drawer storage facility 50 enables random access to every individual blister pack support 20 stored in it containing medicines packaged in the respective original blister pack 10.

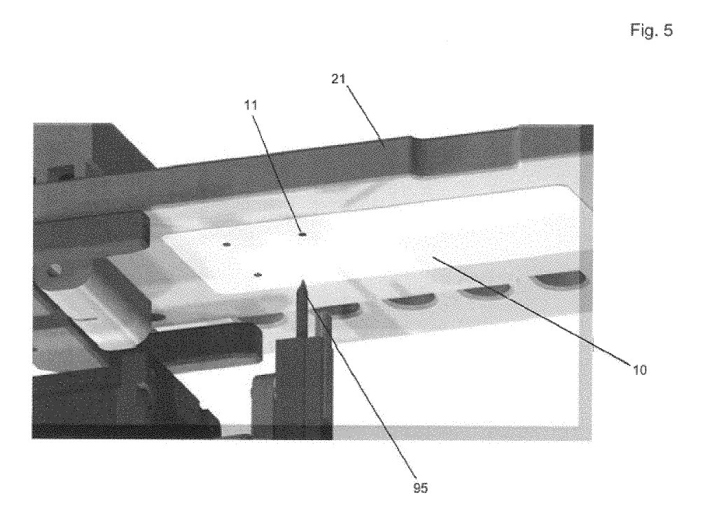

When a specific medicine is needed for filling an organiser blister pack 40, the control system (not illustrated) determines the position of the desired medicine packaged in one of the blister pack supports 20, which is removed from the drawer storage facility 50 with the aid of the actuating mechanism 54 and conveyed by means of a conveyor carriage 68 on the conveyor line 66 to the deblistering device 80, as schematically illustrated in FIG. 4. The blister pack support 20 arrives at the deblistering position, where the medicines 15 are ejected by means of an appropriate ejection ram 82 one after the other into the compartments 74 of a predispensing magazine 70. As illustrated in FIG. 4, the deblistering device 80 of the embodiment illustrated as an example comprises a plurality of ejection rams 82, which are mounted so as to be rotatable about an axis, for example. The shape of the ejection ram 82 is optimised so as to eject the medicines 15 from the respective original blister packs 10 without generating friction and is optimised in particular with respect to the shape of the openings 23 of the blister pack supports 20 used, the shape of the medicines 15 and/or the shape of the blister cavities 12 of the original blister packs 10. In order to optimise the deblistering operation, the deblistering device 70 preferably also has a perforation means 95, schematically illustrated in FIG. 5, and the foil of the original blister pack 10 is perforated at the positions of the blister cavities. Such a perforation process is schematically indicated by reference 11.

In the embodiment of the invention illustrated as an example, the predispensing magazine 70 has seven predispensing compartments 72 corresponding to the seven columns of the organiser blister pack 40 corresponding to days of the week, although a different number of compartments 72 is possible within the scope of the invention. Slots are preferably provided in the bottom region of the side walls of the predispensing compartments 72 to allow a visual check to be made as to whether there is a medicine in the respective predispensing compartment 72 or not.

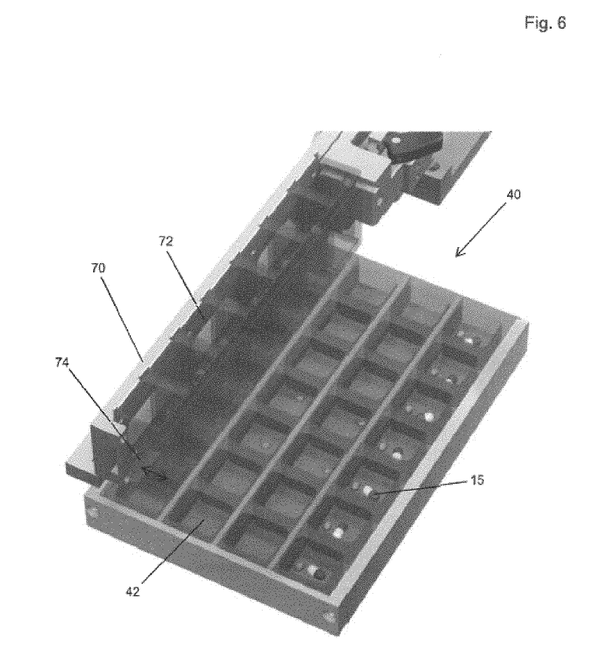

Finally, the medicines are dispensed from the predispensing compartments 72 of the predispensing magazine 70 into the corresponding compartments 42 of the patient-specific organiser blister pack 40, as schematically illustrated in FIG. 6. To this end, the predispensing magazine 70 is positioned above the respective (time of day) row of the organiser blister pack 40 and the medicines 15 are ejected into the respective receiving compartments 42 of the organiser blister pack 40 by pushing back the base part 74 of the predispensing compartments 72. The organiser blister pack 40 has a matrix configuration of receiving compartments 42 which, in the embodiment illustrated as an example, are arranged in four rows corresponding to a number of times over the course of a day when medicines are to be taken (morning, midday, evening, night) and seven columns corresponding to the days of a week. However, the invention is not restricted to this specific layout of receiving compartments 42 of the organiser blister pack.

Sensor devices 90, 92 are also preferably provided, such as light barriers, which monitor the transfer of medicines from the original blister pack 10 to the predispensing magazine and then to the respective compartments 42 of the organiser blister pack 40 and generate an error message in the event of a fault.

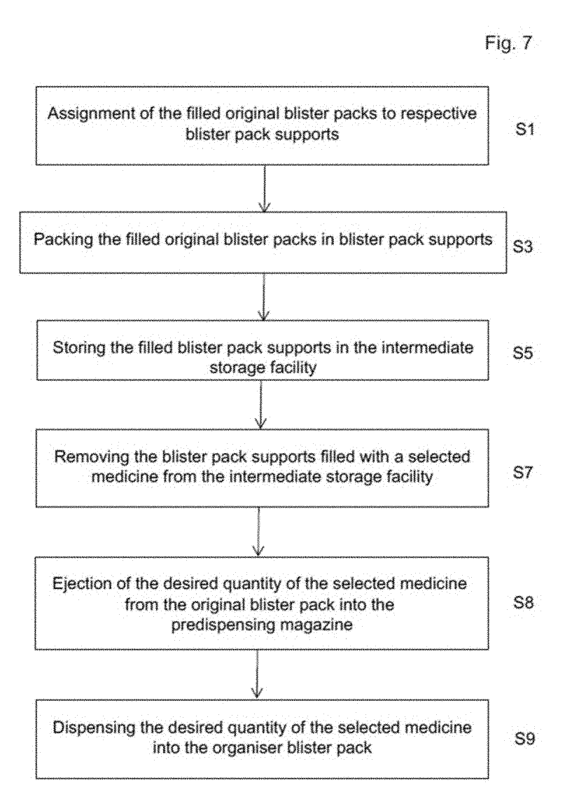

An example of an embodiment of the method proposed by the invention for packing patient-specific organiser blister packs is schematically summarised in the flow diagram illustrated in FIG. 7. The medicines disposed in the original blister pack are assigned to a specific blister pack support in a first method step S1, packed in this blister pack support in method step S3 and temporarily stored in the intermediate storage facility in the following method step S5. In step S7, a selected one of the temporarily stored medicines is then taken out of the intermediate storage facility and conveyed to the deblistering device, where it is ejected into the predispensing magazine in method step S8. In the last method step S9, the selected medicines are dispensed from the predispensing magazine into the corresponding compartments of the organiser blister pack. It should be noted that although it is of advantage to use the predispensing magazine, the invention is not restricted to this.

The invention therefore enables organiser blister packs tailored to individual patients to be filled with a number of different medicines in a controlled manner at a single medicine packaging station. Storing the medicines in the intermediate storage facility in the original blister packs enables a maximum shelf life to be obtained. The (partially) filled original blister packs are stored with the aid of assigned blister pack supports of standardised external dimensions, thereby enabling efficient storage, handling and deblistering of the original blister packs.

The optional use of the predispensing magazine 70 in the packaging installation proposed by the invention ensures that the process of ejection from the original blister pack 10 and the process of filling the organiser blister pack 40 are decoupled from one another. This enables the operation of filling the organiser blister pack 40, which is critical to the efficiency of the installation as a whole in terms of time, to be optimised in terms of speed, whilst making more time available for the ejection operation from the original blister packs 10, which is mechanically more difficult to implement, without impairing the efficiency of the installation as a whole.

1. A method for repackaging a plurality of different medicines from their respective original blister packs into organiser blister packs, comprising:
assigning the original blister packs filled with medicines to a blister pack support of standard external dimensions provided for the respective original blister pack type,
packing the original blister packs filled with medicines in the assigned blister pack support,
intermediately storing the original blister packs packed into the blister pack supports in an intermediate storage facility,
removing from the intermediate storage facility on request the original blister pack, packed into the blister pack support, for a selected one of the plurality of medicines, and
ejecting a defined number of units of the selected medicine from the original blister pack into the organiser blister pack.

2. A method according to claim 1, wherein the blister pack supports each comprise a support part with a number of openings for receiving the blister cavities of the original blister pack, a lid part with the same number of openings as ejection openings for the medicines packaged in the original blister pack, and an identifying means for identifying the respective blister pack support.

3. A method according to claim 2, wherein the blister pack supports comprise different patterns of openings for receiving different original blister packs.

4. A method according to claim 1, wherein, during the medicine ejection process, the original blister pack remains in the blister pack support.

5. A method according to claim 4, wherein the original blister pack is placed onto the blister pack support oriented with its blister cavities facing downwards and the medicines are ejected from the original blister packs in reverse orientation with the blister cavities facing upwards.

6. A method according to claim 1, wherein the medicines are ejected from the original blister pack into a predispensing magazine and are conveyed from there in a time-decoupled second working step into the organiser blister pack.

7. A method according to claim 1, comprising the method step of returning still partly filled original blister packs together with the blister pack support to the intermediate storage facility, while completely empty original blister packs are disposed of.

8. A method according to claim 1, wherein the organiser blister packs are filled with medicines in accordance with predetermined patient-specific prescription data and the organiser blister packs have receiving compartments for respective medicine-administering units arranged in a matrix configuration in rows corresponding to the number of times medicines are to be taken over the course of a day and columns corresponding to a number of days, for example days of the week.

9. A system for repackaging a plurality of different medicines from their respective original blister packs into organiser blister packs, comprising:
a conveying device for singulating and supplying full original blister packs;
an intermediate storage facility with random access for intermediate storage of the original blister packs packed into blister pack supports of standard external dimensions assigned to a respective original blister pack type; and
an ejection device for ejecting a defined number of units of a selected medicine from the respective original blister pack into the organiser blister pack.

10. The system according to claim 9, wherein the intermediate storage facility is configured as a drawer storage facility.

11. The system as claimed in claim 9, wherein the blister pack supports each comprise a support part with a number of openings for receiving the blister cavities of the original blister pack, a lid part with the same number of openings as ejection openings for the medicines packaged in the original blister pack, and an identifying means for identifying the respective blister pack support.

12. The system according to claim 11, wherein the blister pack supports comprise different patterns of openings for receiving different original blister packs.

13. The system according to claim 12, comprising a deblistering device with a plurality of different medicine ejection rams, which are each adapted to a specific medicine and/or original blister pack shape and/or the openings of the blister pack support.

14. The system according to claim 13, wherein the plurality of different medicine ejection rams are mounted rotatably about an axis for random access.

15. The system according to claim 10, comprising a perforation means for perforating the blister film in the area of the blister cavities of the medicines to be ejected from the original blister pack.

16. The system according to claim 14, wherein the medicines are ejected from the original blister pack into a predispensing magazine and are conveyed from there in a time-decoupled second working step into the organiser blister pack.

17. The system according to claim 16, comprising optical sensor means for verifying proper ejection of the selected medicines from the original blister pack into the predispensing magazine and/or correct filling of the organiser blister packs.

18. A blister pack support for receiving an original blister pack with medicines packaged therein, comprising a support part with a number of openings for receiving the blister cavities of the original blister pack, a lid part with the same number of openings as ejection openings for the medicines packaged in the original blister pack, and an identifying means for identifying the blister pack support.

19. A blister pack support according to claim 18, comprising different patterns of openings for receiving differently shaped original blister packs.

20. A blister pack support according to claim 19, wherein the lid part is mounted on the support part by means of a hinge.

21. A blister pack support according to claim 19, wherein the identifying means is an RFID chip.
